(19) United States
(12) Patent Application Publication
(10) Pub. No.: US 2025/0156541 A1
(43) Pub. Date: May 15, 2025

(54) METHOD AND SYSTEM FOR RECOGNIZING MINING MALICIOUS SOFTWARE, AND STORAGE MEDIUM

(71) Applicant: Guangzhou University, Guangzhou City (CN)

(72) Inventors: Shudong Li, Guangzhou City (CN); Qianqing Zhang, Guangzhou City (CN); Xiaobo Wu, Guangzhou City (CN); Laiyuan Jiang, Guangzhou City (CN); Weihong Han, Guangzhou City (CN); Binxing Fang, Guangzhou City (CN); Zhihong Tian, Guangzhou City (CN); Lihua Yin, Guangzhou City (CN); Zhaoquan Gu, Guangzhou City (GD)

(21) Appl. No.: 18/558,042

(22) PCT Filed: Nov. 24, 2021
(86) PCT No.: PCT/CN2021/132838

§ 371 Date: Apr. 29, 2024

(30) Foreign Application Priority Data
Apr. 29, 2021 (CN) 202110471943.2

(51) Int. Cl. G06F 21/56

(52) U.S. Cl. CPC G06F 21/562; G06F 2221/033

(57) ABSTRACT

Disclosed in the present invention are a method and system for recognizing mining malicious software, and a storage medium. The method comprises the following steps: pre-processing data of different dimensions; extracting and vectorizing a text feature; on the basis of Stacking, constructing a mining malicious software recognition model integrated with multiple models; and obtaining a prediction result. The present invention relates to a method for detecting mining malicious software for a binary file, which method is rare at present. The targeting performance is great, the implementation process is simple, and the efficiency is high. In addition, in the present invention, multi-dimensional feature extraction is performed on mining software features by a plurality of angles, a method of multi-model integration is designed for features of different dimensions, and a combined mining malicious software recognition model is constructed, and the model has high recognition accuracy and a low false alarm rate.

### FIELD OF THE INVENTION

The present disclosure belongs to the technical field of network security, and particularly relates to a method and system for recognizing mining malware and a storage medium.

### BACKGROUND OF THE INVENTION

In recent years, with the continuous rise of the economic value of cryptocurrencies, more and more network criminals use malware to occupy system resources and network resources of victims for mining without user's knowledge or permission, so as to obtain the cryptocurrencies for profit-making. Mining malware is generally highly concealed and difficult to detect. Once a computer is invaded, the malware will run silently in the background. As a mining program can consume a large quantity of CPU or GPU resources, and occupy a large quantity of system resources and network resources, it will cause a lagging operation or an abnormal state of a system and the performance of an invaded computer of the user will degrade. A degree of performance degradation will increase with the increase in computing resources occupied by the mining malware. Due to directness of benefits, the mining malware has become one of the most frequently-used attacks by criminals. Every year, a large number of servers in China are infected with the mining malware.

At present, methods for detecting mining Trojans mainly include a method for detecting host computer mining behaviors and a method for detecting web page mining scripts. The method for detecting the host computer mining behaviors mainly includes detecting whether there are mining-related data packages in a traffic transmission package through the extracted traffic based on traffic analysis. The method for detecting the web page mining scripts mainly includes determining whether there are the mining scripts in the to-be-detected page by acquiring features related to the mining scripts of a to-be-detected page and judging a size relationship between an eigenvalue and a preset feature threshold. There are few methods for detecting mining Trojan samples for binary files. Binary-based mining sample detection mainly includes static analysis and dynamic analysis. In a case without executing a program, the static analysis mines the program and extracts useful feature information of the program through lexical analysis, text analysis, a control flow and other technologies based on disassembly, decompilation and other methods. The dynamic analysis captures behaviors for analysis by actually running software.

The existing methods for detecting the mining Trojans mainly focus on the method for detecting host computer mining behaviors and the method for detecting web page mining scripts, lacking an effective and practical detection method for a binary mining sample. Herein, the static method for detecting a mining malware sample based on a binary file is relatively fast and cannot produce a malicious behavior endangering an operating system as it is unnecessary to actually execute malware. However, it is difficult to extract effective features for polymorphic malware, malware variants and shelled malware. A feature code-based detection method and a heuristic-based detection method in the static method are simple and effective, but depend on a feature library and analysis on the mining malware by security personnel, respectively, and are both limited with the increase of the mining malware samples, which results in low detection efficiency. A dynamic analysis method for detecting the mining malware sample based on the binary file needs to really run the malware. For mining malware samples that cannot run, the dynamic method cannot be used to detect them. In addition, simulating all malware behaviors requires continuous monitoring of the malware behaviors, which results in a huge waste of computer resources. Therefore, the dynamic analysis method is not very suitable for detection on a large quantity of mining malware.

### SUMMARY OF THE INVENTION

A main objective of the present disclosure is to overcome the disadvantages and the defects in the prior art, and provide a method and system for recognizing mining malware and a storage medium. The method includes the steps: first, pre-processing binary file samples by using a static analysis method based on multi-dimensional analysis; vectorizing and extracting effective multi-dimensional features of the mining malware; and then, constructing a mining malware recognition model integrated with multiple models. The mining malware recognition model can be applied to an actual network environment to effectively recognize the mining malware.

In order to achieve the above objective, the present disclosure adopts the following technical solution:
the method for recognizing mining malware provided by the present disclosure includes the following steps:
S1, pre-processing data: performing a multi-dimensional data operation on binary samples to obtain corresponding feature data of different dimensions;
S2, extracting text features: extracting and vectorizing features from feature data of different dimensions by combining the TF-IDF algorithm with n-gram; and
S3, on the basis of Stacking, constructing a mining malware recognition model integrated with multiple models and obtaining a prediction result, where the Stacking step includes: dividing feature data sets of different dimensions into a training data set and a test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

As a preferable technical solution, the multi-dimensional data operation includes:
reading files from binary file samples in a form of binary bytecode, then decoding the files into character strings, and screening out a character string with a length in a certain interval;
extracting text data defined in the binary file samples, including a name of a feature operation function, a dynamic link library and text data related to the mining software;
disassembling the binary file samples, and performing feature statistics on section size of the binary file samples; and
disassembling the binary file sample to obtain entry function data of the binary file sample.

As a preferable technical solution, extracting and vectorizing features from feature data of different dimensions by combining a TF-IDF algorithm with the n-gram specifically include the steps:
firstly, generating word items of the n-gram by using feature data of different dimensions;
counting a word frequency that each word item appears, and attaching a weight parameter to each word item; and
computing a final weight for each word item.

As a preferable technical solution, a formula for computing the word frequency that each word item appears is:

$${TF}_{i , j} = \frac{{n}_{i j}}{{\sum }_{k} {n}_{k , j}} ,$$

where TF_{i,j} is a frequency that the word item i appears in the sample j; n_{i,j} is the number of times that the word item i appears in the sample j; and Σₖ n_{k,j} is a total number that the word items appears in the sample j;
a formula for computing a weight parameter is:

$${IDF}_{i , j} = log \frac{\vert D \vert}{\vert j : i ∈ {d}_{j} \vert + 1} ,$$

where IDF_{i,j} is a weight parameter attached to the word item i in the sample j; |D| is the total number of the samples; |j:i∈dⱼ| is the number of the samples containing the word item i; and
a formula for computing the final weight TF−IDF_{i,j} for each word item is:

$$TF - {IDF}_{i , j} = {TF}_{i , j} \times {IDF}_{i , j} .$$

As a preferable technical solution, in the process of generating the word items of the n-gram, the word items with a frequency ratio higher than 0.8 and a frequency value lower than 3 are filtered, and according to the condition of actually generated word items, the number of the word items is limited within a range of [1000, 5000]; in the process of counting the word frequency that each word item appears, the word item features of 1-gram are counted for the n-gram of character string data, the word item features of 1-gram and 2-gram are counted for the n-gram of the text data, and the word item features of 2-gram, 3-gram, 4-gram and 5-gram are counted for the n-gram of an entry function.

As a preferable technical solution, dividing feature data sets of different dimensions into a training data set and a test data set specifically includes the step: dividing four feature data sets of different dimensions obtained by pre-processing and vectorizing the original data sets into the training data set and the test data set,
the training data set includes D₁, D₂, D₃ and D₄:

$${D}_{1} = \{ ( {x}_{1 i} , {y}_{i} ) , i = 1 , 2 , … , m \} ,$$

$${D}_{2} = \{ ( {x}_{2 i} , {y}_{i} ) , i = 1 , 2 , … , m \} ,$$

$${D}_{3} = \{ ( {x}_{3 i} , {y}_{i} ) , i = 1 , 2 , … , m \} ,$$

$${D}_{4} = \{ ( {x}_{4 i} , {y}_{i} ) , i = 1 , 2 , … , m \} ,$$

where xₙᵢ is a feature vector for the iₜₕ sample of the nₜₕ training data set Dₙ, n=1, 2, 3, 4 and so on; yᵢ is a label corresponding to the iₜₕ sample; m is the number of samples in each data set; and
the test data set is set as T.

As a preferable technical solution, on the basis of the XGBoost algorithm, performing K-fold cross validation training in the training data set and obtaining base learners and training results of the base learners, and on the basis of the LightGBM algorithm, performing training in the training results of the base learners and obtaining a meta learner, specifically include the steps:
for K-fold cross validation training, setting D-ₙₖ as a Kₜₕ fold training set of the nₜₕ training data set Dₙ, and setting Dₙₖ as a Kₜₕ fold test set of the nₜₕ training data set Dₙ;
on the basis of the XGBoost algorithm, performing training in the D-ₙₖ to obtain 4 base learners XGBoost_n, where n=1, 2, 3 and 4; for each sample xᵢ in the Dₙₖ,
prediction results of the each sample xᵢ from the base learners XGBoost_n are expressed as Z_{Ki}, and a new data set D_{new}={(Z₁ᵢ, Z₂ᵢ, . . . , Z_{Ki}, yᵢ), i=1, 2, . . . , m} is constructed; and
on the basis of the LightGBM algorithm, performing training in D_{new}, and obtaining a meta learner LightGBM.

As a preferable technical solution, predicting the test data set by using the base learners and the meta learner, and obtaining a final prediction result specifically include the steps:
predicting the test set T by using the base learners to obtain the prediction results W₁, W₂, W₃ and W₄, and constructing a new test data set T_{new}={(W₁, W₂, W₃, W₄)}; and predicting T_{new} with the meta learner to obtain the final prediction result.

In another aspect, the present disclosure further provides a system for recognizing mining malware, and the system is applied to the method for recognizing mining malware, and includes a pre-processing module, a text feature extraction module and a model construction module.

The pre-processing module is used for pre-processing data, and performing multi-dimensional data operation on a binary sample to obtain corresponding feature data of different dimensions.

The text feature extraction module is used for extracting text features, and extracting and vectorizing features from feature data of different dimensions by combining the TF-IDF algorithm with the n-gram.

The model construction module is used for, on the basis of Stacking, constructing a mining malware recognition model integrated with multiple models and obtaining a prediction result, where the Stacking step includes: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

In another aspect, the present disclosure further provides a storage medium, storing a program. When the program is executed by a processor, the method for recognizing the mining malware is implemented.

Compared with the prior art, the present disclosure has the following advantages and benefits:
the existing methods for detecting mining malware mainly focus on detection on host computer mining behaviors and detection on web page mining scripts, lacking an effective and practical detection method for a binary mining sample. Herein, a dynamic method for the mining malware based on a binary file is not suitable for a binary sample that cannot run; and in addition, with the increase of a sample size, the dynamic method will lead to a huge waste of computer resources. The existing static method for the mining malware based on the binary file has a single dimension of feature extraction and low recognition accuracy of a model. However, the present disclosure is to pre-process a data set consisting of binary file samples of the mining malware and non-mining malware by using a static analysis method based on multi-dimensional analysis, then to extract features from preprocessed text data to obtain multi-dimensional features of the mining malware, to design a method integrated with multiple models for features of different dimensions, to train different classifiers for the features of different dimensions based on the XGBoost algorithm, and to construct a combined mining malware recognition model with the classifiers as primary learners for a Stacking integrated model and a LightGBM algorithm as a secondary learner. The model has high recognition accuracy, a low false alarm rate, good comprehensive performance and less resource consumption.

The present disclosure is one of current few methods for detecting the mining malware for the binary files, which has strong pertinence, simple implementation process and high efficiency.

### BRIEF DESCRIPTION OF THE DRAWINGS

FIG. 1 is an overall flowchart of a method for recognizing mining malware in an embodiment of the present disclosure;

FIG. 2 is a schematic structural diagram of a Stacking-based mining malware recognition model in an embodiment of the present disclosure;

FIG. 3 is a schematic diagram of a K-fold cross validation process of the Stacking-based mining malware recognition model in the embodiment of the present disclosure;

FIG. 4 is a schematic structural diagram of a system for recognizing mining malware in an embodiment of the present disclosure; and

FIG. 5 is a schematic structural diagram of a storage medium in an embodiment of the present disclosure.

### DETAILED DESCRIPTION OF THE EMBODIMENTS

In order to enable those skilled in the art to better understand the solutions of the present application, the technical solutions in the embodiments of the present application will be described clearly and completely below with reference to the accompanying drawings in the embodiments of the present application. Apparently, the embodiments described are merely some embodiments rather than all embodiments of the present application. On the basis of the embodiments in the present application, all other embodiments acquired by those skilled in the art without creative efforts fall within a protection scope of the present application.

### Embodiment

The embodiment provides a method for recognizing mining malware. The method includes the steps: first, pre-processing binary file samples by using a static analysis method based on multi-dimensional analysis; vectorizing and extracting effective multi-dimensional features of the mining malware; and then, constructing a mining malware recognition model integrated with multiple models.

As shown in FIG. 1, the method in the embodiment specifically includes the following steps:
at S1, data is pre-processed: multi-dimensional data operation is performed on an original binary sample data set consisting of mining malware and non-mining malware to obtain corresponding feature data of different dimensions.

More specifically, in step S1, the multi-dimensional data operation includes:
files are read from binary file samples in a form of binary bytecode, then the files are decoded into character strings, and a character string with a length in a certain interval is screened out;
text data defined in the binary file samples is defined, including a name of a feature operation function (Socket, CreateRemoteThread, etc.), a dynamic link library (Kernel32.dll, Powerprof.dll, etc.) and text data related to the mining software (pool, https, connection, Reg, cpu, gpu, coin, etc.);
the binary file samples are disassembled, and feature statistics are performed on their section size (UPX0, UPX2, reloc, text, data, rdata, etc.); and
the binary file sample is disassembled to obtain entry function data of the binary file sample.

At S2, text features are extracted: features are extracted and vectorized from feature data of different dimensions by combining the TF-IDF algorithm with n-gram.

More specifically, in the embodiment, in step S2, a word frequency feature of a text is computed by the TF-IDF method for computing the character strings and an entry function in combination with the n-gram; the text data undergoes feature vectorization to form a semantic matrix; and two different feature vector data sets are obtained. The specific steps are as follows:
at S2.1, firstly, word items of the n-gram are generated for the text data (the character strings and the entry function) in step S1.
At S2.2, a word frequency that each word item appears is counted, and a weight parameter is attached to each word item;
a formula for computing the word frequency that each word item appears is:

$${TF}_{i , j} = \frac{{n}_{i j}}{{\sum }_{k} {n}_{k , j}} ,$$

where TF_{i,j} is a frequency that the word item i appears in the sample j; n_{i,j} is the number of times that the word item i appears in a sample j; and Σₖ n_{k,j} is a total number of the word items appearing in the sample j.

A formula for computing a weight parameter is:

$${IDF}_{i , j} = log \frac{\vert D \vert}{\vert j : i ∈ {d}_{j} \vert + 1} ,$$

where IDF_{i,j} is a weight parameter attached to the word item i in the sample j; |D| is a total number of the samples; and |j:i∈dⱼ| is the number of the samples containing the word item i. In order to prevent a denominator from being zero, 1 is added.

At S2.3, a final weight for each word item is attached.

A formula for computing the final weight TF−IDF_{i,j} for each word item is:

$$TF - {IDF}_{i , j} = {TF}_{i , j} \times {IDF}_{i , j} .$$

More specifically, in the process of generating the word items of n-gram described in step S2.1, in order to prevent too many features generated by n-gram, the word item features with a frequency ratio higher than 0.8 and a frequency value lower than 3 are filtered, and according to the condition of actually generated word items, the number of the word item features is limited within a range of [1000, 5000]; in the process of counting the word frequency that each word item appears described in step S2.2, the word item features of 1-gram are counted for n-gram of character string data, the word item features of 1-gram and 2-gram are counted for the n-gram of the text data, and the word item features of 2-gram, 3-gram, 4-gram and 5-gram are counted for the n-gram of the entry function. The actual word item length may be selected in combination with a model score.

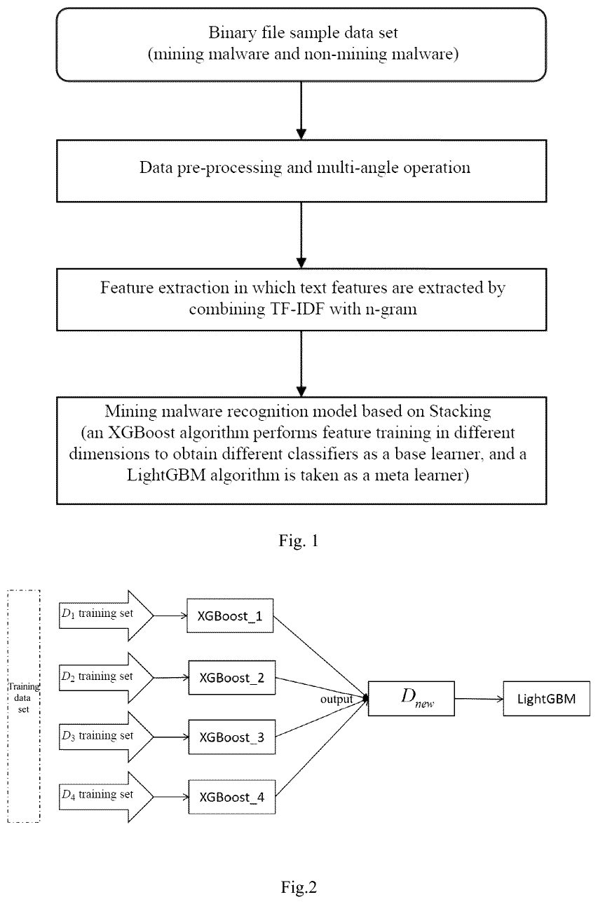

At S3, on the basis of Stacking, a mining malware recognition model integrated with multiple models is constructed, and the prediction result is obtained, as shown in FIG. 2.

At S3.1, feature data sets of different dimensions are divided into the training data set and the test data set:
four feature data sets of different dimensions obtained by pre-processing and vectorizing the original data sets are divided into the training data set and the test data set,
the training data set includes D₁, D₂, D₃ and D₄:

$${D}_{1} = \{ ( {x}_{1 i} , {y}_{i} ) , i = 1 , 2 , … , m \} ,$$

$${D}_{2} = \{ ( {x}_{2 i} , {y}_{i} ) , i = 1 , 2 , … , m \} ,$$

$${D}_{3} = \{ ( {x}_{3 i} , {y}_{i} ) , i = 1 , 2 , … , m \} ,$$

$${D}_{4} = \{ ( {x}_{4 i} , {y}_{i} ) , i = 1 , 2 , … , m \} ,$$

where xₙᵢ is a feature vector for the iₜₕ sample of the nₜₕ training data set Dₙ, n=1, 2, 3, 4 and so on; yᵢ is a label corresponding to the iₜₕ sample; m is the number of samples in each data set; and
the test data set is set as T.

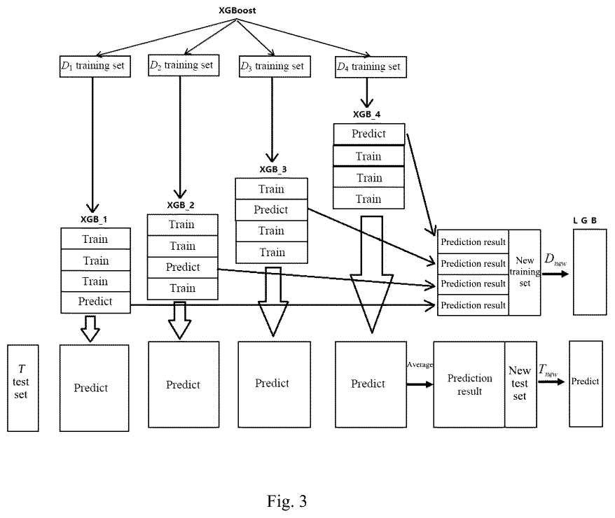

At S3.2, on the basis of the XGBoost algorithm, K-fold cross validation training is performed in the training set, and base learners and training results of the base learners are obtained:
a K-fold cross validation process of the Stacking-based mining malware recognition model is shown in FIG. 3:
for K-fold cross validation training, D-_{nK} is set as the Kₜₕ fold training set of the nₜₕ training data set Dₙ, and four base learners XGBoost_n are obtained by training in D-_{nK} based on XGBoost algorithm, where n=1, 2, 3, 4.

At S3.3, on the basis of the LightGBM algorithm, training is performed in the training results of the base learners, and a meta learner is obtained:
for K-fold cross validation training, D_{nK} is set as the K^{th} fold test set of the n^{th} training data set Dₙ; for various samples xᵢ in D_{nK}, their prediction results from the base learners XGBoost_n are expressed as Z_{Ki}, constituting a new data set D_{new}={(Z₁ᵢ, Z₂ᵢ, . . . , Z_{Ki}, yᵢ), i=1, 2, . . . , m}; and training is performed in D_{new} based on the LightGBM algorithm to obtain the meta learner LightGBM.

At S3.4, the test data set is predicted by using the base learners and the meta learner, and a final prediction result is obtained.

The test set T is predicted by using the base learners XGBoost_n to obtain the prediction results W₁, W₂, W₃ and W₄, and a new test data set T_{new}={(W₁, W₂, W₃, W₄)} is constructed. The final prediction result is obtained by predicting T_{new} with the meta learner LightGBM.

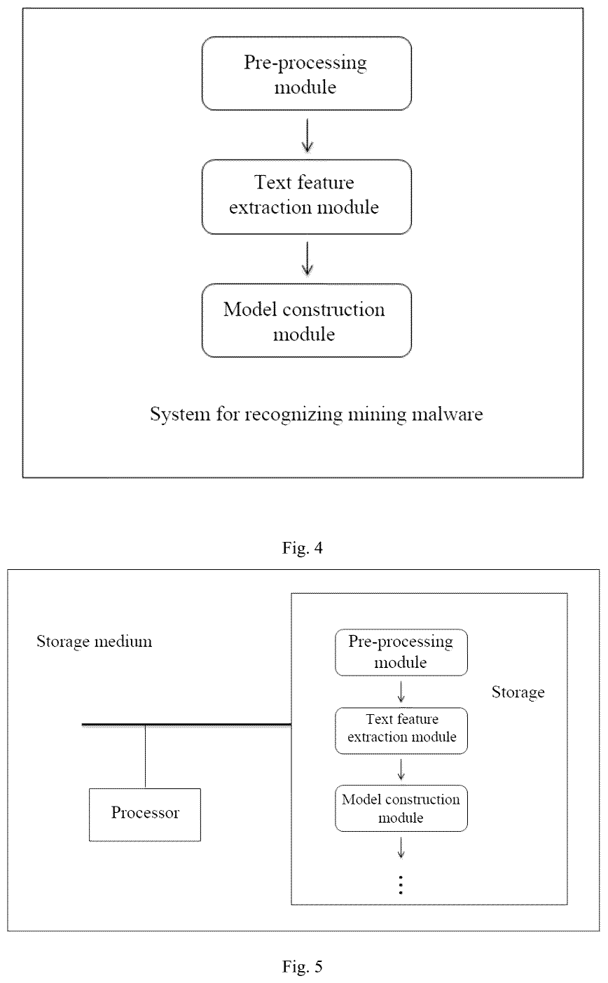

As shown in FIG. 4, in another embodiment, a system for recognizing mining malware is provided, including a pre-processing module, which is used for pre-processing data, and performing multi-dimensional data operation on binary samples to obtain corresponding feature data of different dimensions;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, where the Stacking step includes: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

Here, it is to be noted that the system provided by the above-described embodiment is only described by the division of the functional modules described above. In practice application, the functions can be completed by distributing to different functions modules as needed, that is, the internal structure is divided into different functional modules to complete all or a part of the functions described above. The system is applied to the method for recognizing the mining malware in the above embodiment.

As shown in FIG. 5, in another embodiment of the present application, a storage medium is further provided, storing a program. When the program is executed by a processor, the method for recognizing the mining malware of the above embodiments is implemented, specifically including:
S1, pre-processing data: performing a multi-dimensional data operation on binary samples to obtain corresponding feature data of different dimensions;
S2, extracting text features: extracting and vectorizing features from feature data of different dimensions by combining the TF-IDF algorithm with n-gram; and
S3, on the basis of Stacking, constructing a mining malware recognition model integrated with multiple models and obtaining a prediction result, where the Stacking step includes: dividing feature data sets of different dimensions into a training data set and a test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

It should be understood that various parts of the present application can be implemented with hardware, software, firmware or a combination thereof. In the above implementation, multiple steps or methods may be implemented with the software or the firmware stored in a memory and executed by an appropriate instruction execution system. For example, if they are implemented by the hardware, as the same in another implementation, they may be implemented by any one of the following technologies known in the art or their combination: a discrete logic circuit with a logic gate circuit for achieving a logic function of a data signal, a special integrated circuit with an appropriate combination logic gate circuit, a programmable gate array (PGA), a field programmable gate array (FPGA), etc.

The above embodiments are preferred implementation of the present disclosure, but the implementation of the present disclosure is not limit by above embodiments. Any other changes, modifications, substitutions, combinations and simplifications made without departing from the spirit and principle of the present disclosure shall be equivalent replacement methods, and fall within the scope of protection of the present disclosure.

1: A method for recognizing mining malware, comprising the following steps:
pre-processing data: performing multi-dimensional data operation on a binary sample, and obtaining corresponding feature data of different dimensions,
wherein the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples;
disassembling the binary file samples to obtain entry function data of the binary file samples;
extracting text features: extracting and vectorizing features from feature data of different dimensions by combining a TF-IDF algorithm with n-gram;
on the basis of Stacking, constructing a mining malware recognition model integrated with multiple models and obtaining a prediction result, wherein the step of Stacking comprises: dividing feature data sets of different dimensions into a training data set and a test data set; on the basis of an XGBoost algorithm, performing K-fold cross validation training in the training set, and obtaining base learners and training results of the base learners; on the basis of a LightGBM algorithm, performing training in the training results of the base learners, and obtaining a meta learner; and predicting the test data set by using the base learners and the meta learner, and obtaining a final prediction result.

2: The method for recognizing mining malware according to claim 1, wherein extracting and vectorizing features from feature data of different dimensions by combining a TF-IDF algorithm with the n-gram specifically comprise the steps:
firstly, generating word items of the n-gram by using feature data of different dimensions;
counting a word frequency that each word item appears, and attaching a weight parameter to each word item; and
computing a final weight for each word item.

3: The method for recognizing mining malware according to claim 2, wherein a formula for computing the word frequency that each word item appears is:
$$\text{?} = \frac{\text{?}}{\text{?}} ,$$
$$\text{?} \text{indicates text missing or illegible when filed}$$
wherein TF_{i,j} is a frequency that the word item i appears in a sample j; n_{i,j} is the number of times that the word item i appears in the sample j; and Σₖ n_{k,j} is a total number of the word items appearing in the sample j;
a formula for computing a weight parameter is:
$$ID \text{?} = log \frac{\vert \text{?} \vert}{\vert \text{?} \vert + 1} ,$$
$$\text{?} \text{indicates text missing or illegible when filed}$$
wherein IDF_{i,j} is a weight parameter attached to the word item i in the sample j; |D| is the total number of the samples; |j:i∈dⱼ| is the number of the samples containing the word item i; and
a formula for computing the final weight TF−IDF_{i,j} for each word item is:
$$TF - ID \text{?} = T \text{?} \times ID \text{?} .$$
$$\text{?} \text{indicates text missing or illegible when filed}$$

4: The method for recognizing mining malware according to claim 2, wherein in the process of generating the word items of n-gram, the word items with a frequency ratio higher than 0.8 and a frequency value lower than 3 are filtered, and according to the condition of actually generated word items, the number of the word items is limited within a range of [1000, 5000]; in the process of counting the word frequency that each word item appears, the word item features of 1-gram are counted for the n-gram of character string data, the word item features of 1-gram and 2-gram are counted for the n-gram of the text data, and the word item features of 2-gram, 3-gram, 4-gram and 5-gram are counted for the n-gram of an entry function.

5: The method for recognizing mining malware according to claim 1, wherein dividing feature data sets of different dimensions into a training data set and a test data set specifically comprises the step: dividing four feature data sets of different dimensions obtained by pre-processing and vectorizing the original data sets into the training data set and the test data set,
the training data set comprises D₁, D₂, D₃ and D₄:
$${D}_{1} = \{ ( \text{?} ) , \text{?} = 1 , 2 , … , m \} ,$$
$${D}_{2} = \{ ( \text{?} ) , \text{?} = 1 , 2 , … , m \} ,$$
$$\text{?} = \{ ( \text{?} ) , \text{?} = 1 , 2 , … , m \} ,$$
$${D}_{4} = \{ ( \text{?} ) , \text{?} = 1 , 2 , … , m \} ,$$
$$\text{?} \text{indicates text missing or illegible when filed}$$
wherein xₙᵢ is a feature vector for the iₜₕ sample of the nₜₕ training data set Dₙ, n=1, 2, 3, 4 and so on; yᵢ is a label corresponding to the iₜₕ sample; m is the number of samples in each data set; and
the test data set is set as T.

6: The method for recognizing mining malware according to claim 1, wherein on the basis of the XGBoost algorithm, performing K-fold cross validation training in the training data set and obtaining base learners and training results of the base learners, and on the basis of the LightGBM algorithm, performing training in the training results of the base learners and obtaining a meta learner, specifically comprise the steps:
for K-fold cross validation training, setting D-_{nK} as a Kₜₕ fold training set of the nₜₕ training data set Dₙ, and setting D_{nK} as a Kₜₕ fold test set of the nₜₕ training data set Dₙ;
on the basis of the XGBoost algorithm, performing training in the D-_{nK} to obtain 4 base learners XGBoost_n, wherein n=1, 2, 3 and 4; for each sample xᵢ in the D_{nK},
prediction results of the each sample xi from the base learners XGBoost_n are expressed as Z_{Ki}, and a new data set D_{new}={(Z₁ᵢ, Z₂ᵢ, . . . , Z_{Ki}, yᵢ), i=1, 2, . . . , m} is constructed; and
on the basis of the LightGBM algorithm, performing training in D_{new}, and obtaining a meta learner LightGBM model.

7: The method for recognizing mining malware according to claim 1, wherein predicting the test data set by using the base learners and the meta learner, and obtaining a final prediction result specifically comprise the steps:
predicting the test set T by using the base learners to obtain the prediction results W₁, W₂, W₃ and W₄, and constructing a new test data set T_{new}={(W₁, W₂, W₃, W₄)}; and predicting T_{new} with the meta learner to obtain the final prediction result.

8: A system for recognizing mining malware, applied to the method for recognizing mining malware according to claim 1, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

9: A storage medium, storing a program, wherein when the program is executed by a processor, the method for recognizing the mining malware according to claim 1 is implemented.

10: A system for recognizing mining malware, applied to the method for recognizing mining malware according to claim 2, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

11: A system for recognizing mining malware, applied to the method for recognizing mining malware according to claim 3, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

12: A system for recognizing mining malware, applied to the method for recognizing mining malware according to claim 4, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

13: A system for recognizing mining malware, applied to the method for recognizing mining malware according to claim 5, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

14: A system for recognizing mining malware, applied to the method for recognizing mining malware according to claim 6, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

15: A system for recognizing mining malware, applied to the method for recognizing mining malware according to claim 7, and comprises a pre-processing module, a text feature extraction module and a model construction module,
the pre-processing module is used for pre-processing data, and performing multi-dimensional data operation on a binary sample to obtain corresponding feature data of different dimensions;
the multi-dimensional data operation comprises:
reading files from binary file samples in a form of binary bytecode, then decoding the files into character strings, and screening out a character string with a length in a certain interval;
extracting text data defined in the binary file samples, comprising a name of a feature operation function, a dynamic link library and text data related to the mining software;
disassembling the binary file samples, and performing feature statistics on section size of the binary file samples; and
disassembling the binary file samples to obtain entry function data of the binary file samples;
the text feature extraction module is used for extracting text features, and extracting and vectorizing features from feature data of different dimensions by combining the TF-IDF algorithm with the n-gram;
the model construction module is used for, on the basis of Stacking, constructing a mining malware recognition model integrated with multiple models and obtaining a prediction result, wherein the Stacking step comprises: dividing feature data sets of different dimensions into the training data set and the test data set; on the basis of the XGBoost algorithm, performing K-fold cross validation training in the training data set and obtaining base learners and training results of the base learners, and on the basis of the LightGBM algorithm, performing training in the training results of the base learners and obtaining a meta learner; and predicting the test data set by using the base learners and the meta learner and obtaining a final prediction result.

16: A storage medium, storing a program, wherein when the program is executed by a processor, the method for recognizing the mining malware according to claim 2 is implemented.

17: A storage medium, storing a program, wherein when the program is executed by a processor, the method for recognizing the mining malware according to claim 3 is implemented.

18: A storage medium, storing a program, wherein when the program is executed by a processor, the method for recognizing the mining malware according to claim 4 is implemented.

19: A storage medium, storing a program, wherein when the program is executed by a processor, the method for recognizing the mining malware according to claim 5 is implemented.

20: A storage medium, storing a program, wherein when the program is executed by a processor, the method for recognizing the mining malware according to claim 6 is implemented.
